(19) United States
(12) Patent Application Publication
(10) Pub. No.: US 2012/0305121 A1
(43) Pub. Date: Dec. 6, 2012

(54) FIBERBOARD TUBE AND CLOSURE ASSEMBLY

(76) Inventor: Samuel Sanchez, McAllen, TX (US)

(21) Appl. No.: 13/152,557

(22) Filed: Jun. 3, 2011

(51) Int. Cl. F16L 55/10; B31C 1/04

(52) U.S. Cl. 138/89; 493/308

(57) ABSTRACT

A biodegradable tube and closure component for containing a viscous substance and method for assembling the biodegradable tube and closure component includes a fiber board tube with a heat sealable inner surface and a polymer closure component inserted into one end of the fiber board tube and welded therein by heat or ultrasonically welding. The assembled biodegradable tube and closure component can be filled with a desired viscous substance through an opposite open end of the cylindrical tube and then the opposite open end closed to form a biodegradable fiberboard tube and closure assembly filled with the viscous substance.

### FIELD OF THE INVENTION

The present invention relates generally to a fiberboard tube and closure assembly. More specifically, the present invention relates to a fiberboard tube with a heat sealable inner layer in which the closure piece is sealed thereto.

### BACKGROUND OF THE INVENTION

Fiberboard is a paper-like material usually over 0.01 inches (0.25 mm) thick sometimes called paperboard or cardboard. Cardboard might also be any heavy paper-pulp based board. Fiberboard tubes are conventionally formed by adhesively bonding two or more continuous strips of paper to each other in overlapping layers around a cylindrical mandrel and then cutting the fiberboard cylinder or tube thus formed to desired length. The open ends of the fiberboard tube can then be closed using a suitable end closure to form a container that is both light and strong.

A variety of end closures are known in the art for closing the open end of a fiberboard tube. A very popular type is known in the industry as a plastic end cap or plug. Plastic plugs are relatively simple to manufacture, inexpensive and lightweight. However, it is often the case that the manufacturing process of producing the fiberboard tube with the plastic top is not environmentally friendly.

### SUMMARY OF THE INVENTION

According to the present invention, a method to assemble a biodegradable tube and closure component for containing a viscous substance is disclosed. The method includes providing a fiber board tube with a heat sealable inner surface; providing a polymer closure component; inserting the closure component into one end of the fiber board tube; and welding the closure component to the one end of the fiber board.

Further according to the present invention, a biodegradable tube and closure component for containing a viscous substance comprises: a fiber board tube with a heat sealable inner surface; a polymer closure component inserted into one end of the fiber board tube; and the closure component welded to the one end of the fiber board.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a three-dimensional side view of the fiberboard tube with an ultrasonically welded closure piece, in accordance with the present invention.

FIG. 2 is a three-dimensional exploded side view of the fiberboard tube and the closure piece, in accordance with the present invention.

FIG. 3 is a three-dimensional side view of the fiberboard tube with the ultrasonically welded closure piece and the welder, in accordance with the present invention.

FIG. 4 is a three-dimensional side view of the fiberboard tube with the ultrasonically welded closure piece in combination with a substance injector, in accordance with the present invention.

FIG. 5 is a three-dimensional side view of the sealed fiberboard tube with ultrasonically welded closure piece, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

The present invention is directed to an innovative and environmentally conscious manner of manufacturing a fiberboard tube with a closure piece. In broad terms, low temperature ultrasonic welding or heat sealing is utilized to secure, preferably hermetically, the closure piece to the fiberboard tube.

Referring to FIG. 1, a fiberboard tube and closure assembly 10 is illustrated. The fiberboard tube and closure assembly 10 is adapted to house a substance that is injected into the assembly 10. This substance is generally of a viscous consistency, such as sunscreen or other lotions.

The fiberboard tube and closure assembly 10 is designed to be biodegradable when it is disposed of after use. The fiberboard tube and closure assembly 10 includes a hollow cylindrical tube 12 with two opposite open ends 14 and 16 (as seen in FIG. 2) and a closer piece 20 (as shown in FIG. 2). The hollow cylindrical tube 12 is constructed of fiberboard that can be printed thereon and with a heat sealable inner lining 17. The inner surface or wall 18 of the hollow cylindrical tube 12 is coated with a heat sealable lining 17 that is environmentally friendly. The heat sealable lining 17 can be a uniform thermoplastic monolayer or a material with multiple layers, at least one of which is a thermoplastic layer. As discussed below, heat sealing can join two similar materials together or join dissimilar materials wherein one of which has a thermoplastic layer.

The heat sealable inner lining 17 is constructed of plastic materials, either a mono layer or multiple layers, wherein at least one is a thermoplastic layer, that can be heat sealed and/or ultrasonic sealed. Further the closer piece 20 can also be constructed from the same materials. These include:
ACN Acrylonitrile
BOPP Biaxially Oriented Polypropylene
BON Biaxially Oriented Nylon
CA Cellulose Acetate
CTFE Chlorotrifluoroethylene/Aclar
EAA Ethylene Acrylic Acid
EEA Ethylene-Ethyl Acrylate
EMA Ethylene-Methyl Acrylate
EVA Ethylene-Vinyl Acetate
EVOH Ethylene-Vinyl Alcohol
HIPS High Impact Polystyrene
SUR Ionomer/Surlyn
LDPE Low-Density Polyethylene
LLDPE Linear Low-Density Polyethylene
mPE Metallocene Polyethylene
OPP Oriented Polypropylene
PA Polyamide
PAN Polyacrylonitrile/Barex
PB Polybutylene
PE Polyethylene
PET Poly(Ethylene Terephthalate)/Polyester
PETG Poly(Ethylene Terephthalate) Glycol
PLA Poly(Lactic Acid)
PP Polypropylene
PS Polystyrene
PTFE Polytetrafluoroethylene/Teflon
PUR Polyurethane
PVC Poly(Vinyl Chloride)
PVDC Poly(Vinylidene Chloride)

An important advantage of the forming the hollow cylindrical fiberboard tube 12 is that approximately 40-50% of the plastic material has been eliminated from a conventional plastic tube typically used to house a viscous substance.

As seen in FIG. 2, the fiberboard tube and closure assembly 10 has a closure piece 20, such as a “flip-top” lid that is shown, mounted to the open end 14. While a flip top closure is shown, it is within the terms of the invention to incorporate any type of closure piece such as but not limited to a disc top, a bullet top, and a top suitable for applying lip balm. The flip-top closure piece 20 includes a cylindrical lip 21 extending from one end 23a of the cylindrical top section 23. The cylindrical lip 21 can have a length of between about 0.125 inches and about 0.5 inches. The top surface of the cylindrical top section 23 (not shown) covers the end of the top section and includes an aperture (not shown) extending there through. The flip top section 25 of the flip-top closure piece 20 is typically mounted by a hinged portion (not shown) to the cylindrical top section 23 and includes a plug that seals the aperture.

The flip-top closure piece 20 can be mounted to the open end 14 of the cylindrical tube 12 by inserting the cylindrical lip 21 having an outer diameter D₁ into the open end 14 of hollow cylindrical tube 12. The end 23a of cylindrical top section 23 abuts against the cylindrical wall of the open end 14 of tube 12. Preferably, the cylindrical lip 21 forms a friction fit with the inner wall 18 of the hollow cylindrical tube 12. Closure piece 20 uses has a cylindrical lip 21 which is shorter than a typical cylindrical lip of a prior art flip-top closure piece which is about 40% longer than the cylindrical lip of the present invention. The use of the narrower cylindrical lip for the flip-top closure piece of the present invention is designed to use less plastic than the traditional closure piece in an effort to make the fiberboard tube and closure assembly 10 as environmentally friendly as possible.

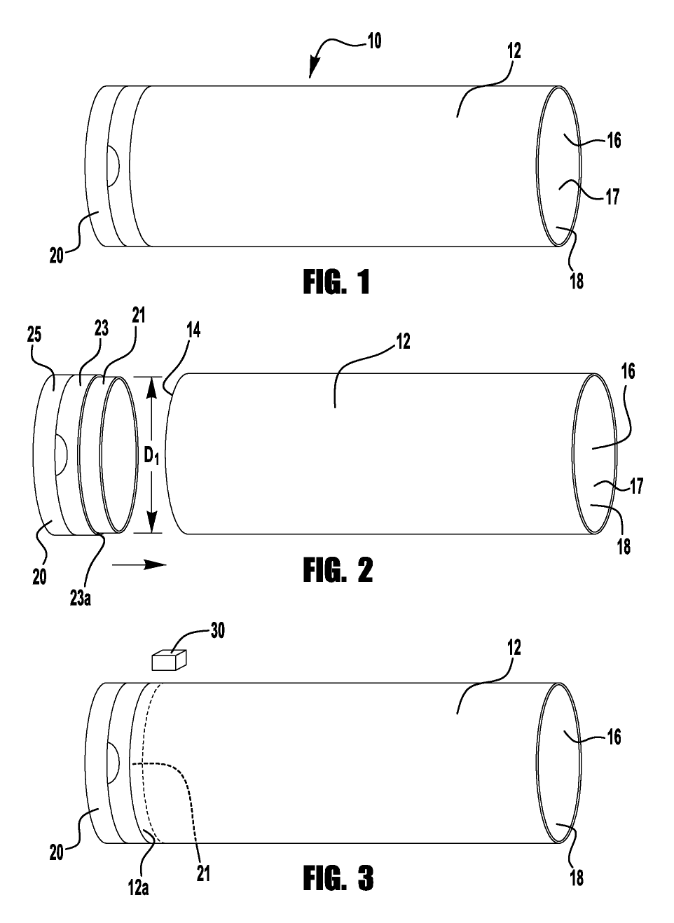

The cylindrical lip 21 of closure piece 20 is fitted into the open end 14 of the hollow cylindrical tube 12 and then secured therein using ultrasonic sealing, also referred to as ultrasonic welding wherein the closure piece 20 is bonded and sealed within the open end of the hollow cylindrical tube 12 by using localized heat developed by vibratory mechanical pressure at ultrasonic frequencies. The ultrasonic welding device 30, as seen in FIG. 3, applies high-frequency ultrasonic acoustic vibrations to the area 12a of the tube 12 covering the lip 21. In practice, the lip 21 is first removably secured within the open end 14 of tube 12 by friction and then the ultrasonic device 30 locally applies the high-frequency ultrasonic acoustic vibrations in the frequency range of operation, i.e., about 20 kHz to about 35 kHz, to the area 12a covering the lip 21 to create a strong hermetic seal. This ultrasonic welding technique utilizes low heat and is an environmentally friendly process. Nearly all packaging materials and laminates with a thermoplastic sealing layer or coating are suitable for the use of ultrasonic technology. This is the novel and preferred approach to the mounting of a closure piece 20 which previously was secured within a tube by an adhesive.

In the prior art, closure piece 20 is fitted into the open end 14 of the hollow cylindrical tube 12 and then secured therein using an adhesive. Being that the adhesives used in the prior art are not biodegradable this is not currently an environmentally friendly option due to the biodegradability. For an adhesive to meet eco-friendly standards, the ASTM defines what constitutes “biodegradability.” Biodegradability means that a product is “capable of undergoing decomposition into carbon dioxide, methane, water, inorganic compounds, or biomass in which the predominant mechanism is the enzymatic action of microorganisms that can be measured by standardized tests, in a specific period of time, reflecting available disposal conditions.”

It is also within the terms of the invention to utilize heat sealing, also known as heat welding to hermetically secure a closure piece 20 fitted into the open end 14 of the hollow cylindrical tube 12. As discussed before, the cylindrical tube 12 can have an inner layer 17 comprising a uniform thermoplastic monolayer or multiple layers, at least one being thermoplastic. The closure piece can be constructed of a thermoplastic material which is the same as the monolayer or the thermoplastic of the multiple layers. Heat sealing can join two similar materials together or can join dissimilar materials, one of which has a thermoplastic layer. In this case, either the closure piece 20, or the hollow cylindrical portion 12, or both may be a thermoplastic material in order to effectively utilize heat sealing. The temperature range of heart sealing is between about 175° C. and 275° C. The breadth of this temperature range is due to a variety of factors. These factors include various types of plastics that may be used with differing melting points, the thickness of the hollow cylindrical fiberboard tube 12 as well as the thickness of its inner plastic layer 17, and the speed of production which when increased, requires higher heat or frequency, as well as increased dwell time, and pressure adjustments.

As seen in FIG. 4, after the closure piece 20 is fitted into the open end 14 of the hollow cylindrical tube 12, a substance injector 22 inserts the desired substance, such as sunscreen, lotion, toothpaste, etc. into the open end 16 of the hollow cylindrical tube 12. This filling process may be done manually, semi-automatically, or with standard tube filling equipment.

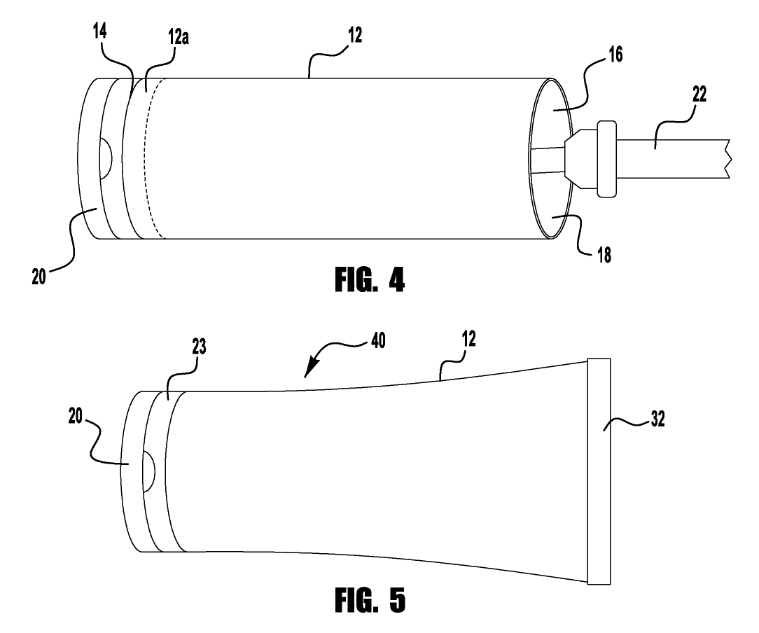

Once the substance has been injected into the hollow cylindrical portion 12, open end 16 is closed and sealed at 32, as seen in FIG. 5. This heat-sealing process may be made using any method available for sealing plastic tubes as described above.

In use, hollow cylindrical tube 12 of the completed fiberboard tube and closure assembly 10, after it has been filled with a substance and has the end 18 sealed closed to form a biodegradable fiberboard tube and closure assembly 40 filled with a viscous substance 10, as shown in FIG. 5. The fiberboard tube 12 of biodegradable fiberboard tube and closure assembly 40 is malleable so that when the user applies pressure to the tube 12, the contents are forced out through an opening in the closure piece 20 as is conventionally known.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A method to assemble a biodegradable tube and closure component for containing a viscous substance, comprising:
providing a fiber board tube with a heat sealable inner surface;
providing a polymer closure component;
inserting the closure component into one end of the fiber board tube; and
welding the closure component to the one end of the fiber board.

2. The method of claim 1 including providing the fiber board tube from a hollow cylindrical tube having two opposite open ends with the heat sealable inner surface being a coating of a heat sealable inner lining .

3. The method of claim 2 including forming the coating of a heat sealable inner lining of a uniform thermoplastic monolayer.

4. The method of claim 2 including forming the coating of a heat sealable inner lining of a material with multiple layers including at least one thermoplastic layer.

5. The method of claim 2 wherein welding the closure component to the one end of the fiber board includes heat sealing the closure component to the coating of the heat sealable inner lining of the hollow cylindrical tube.

6. The method of claim 2 wherein welding the closure component to the one end of the fiber board includes ultrasonic welding the closure component to the heat sealable inner lining of the hollow cylindrical tube.

7. The method of claim 1 wherein inserting the closure component into one end of the fiber board tube includes inserting a cylindrical lip extending from one end of the closure component into the one end of the fiber board tube.

8. The method of claim 7 wherein welding the closure component to the one end of the fiber board includes ultrasonic welding by applying high-frequency ultrasonic acoustic vibrations in the frequency range of about 20 kHz to about 35 kHz to the fiber board tube covering the cylindrical lip of the closure member to create a strong hermetic seal.

9. The method of claim 2 wherein welding the closure component to the one end of the fiber board includes heat welding in the temperature range of between about 175° C. and 275° C. to the fiber board tube covering the cylindrical lip of the closure member to create a strong hermetic seal.

10. The method of claim 2 further including:
inserting a desired viscous substance into the opposite open end of the hollow cylindrical tube; and
closing and sealing the opposite open end to form a biodegradable fiberboard tube and closure assembly filled with the viscous substance.

11. A biodegradable tube and closure component for containing a viscous substance, comprising:
a fiber board tube with a heat sealable inner surface;
a polymer closure component inserted into one end of the fiber board tube; and the closure component welded into the one end of the fiber board.

12. The biodegradable tube and closure component of claim 11 wherein the hollow cylindrical tube has two opposite open ends and is coated with a heat sealable inner lining .

13. The biodegradable tube and closure component of claim 12 wherein the heat sealable inner lining of the cylindrical tube is a uniform thermoplastic monolayer.

14. The biodegradable tube and closure component of claim 12 wherein the heat sealable inner lining of the cylindrical tube is a material with multiple layers including at least one thermoplastic layer.

15. The biodegradable tube and closure component of claim 12 wherein the closure component includes a cylindrical lip extending from one end of the closure element and the cylindrical lip is disposed into the one end of the fiber board tube.

16. The biodegradable tube and closure component of claim 15 wherein the closure component welded into the one end of the fiber board is ultrasonically welded to the heat sealable inner lining of the hollow cylindrical tube.

17. The biodegradable tube and closure component of claim 16 wherein the closure component welded into the one end of the fiber board is ultrasonically welded to the heat sealable inner lining of the hollow cylindrical tube covering the cylindrical lip of the closure member by high-frequency ultrasonic acoustic vibrations in the frequency range of about 20 kHz to about 35 kHz of the fiber board tube to create a strong hermetic seal.

18. The biodegradable tube and closure component of claim 15 wherein the closure component welded into the one end of the fiber board is heat sealed to the heat sealable inner lining of the hollow cylindrical tube.

19. The biodegradable tube and closure component of claim 18 wherein the closure component welded into the one end of the fiber board is heat welded to the heat sealable inner lining of the hollow cylindrical tube covering the cylindrical lip of the closure member by heat welding in the temperature range of between about 175° C. and 275° C. the fiber board tube covering the cylindrical lip of the closure member to create a strong hermetic seal.

20. The biodegradable tube and closure component of claim 12 wherein subsequent to the hollow cylindrical tube being filled with a desired viscous substance through an opposite open end of the cylindrical tube, the opposite open end is closed and to form a biodegradable fiberboard tube and closure assembly filled with the viscous substance.
